(19) United States
(12) Patent Application Publication
(10) Pub. No.: US 2025/0098654 A1
(43) Pub. Date: Mar. 27, 2025

(54) Attachment For Fishing Bobber

(71) Applicant: KB Bobber Lights LLC, Cincinnati, OH (US)

(72) Inventors: Bobby Henderson, Cincinnati, OH (US); Kendal Munro, Cincinnati, OH (US)

(73) Assignee: KB Bobber Lights LLC, Cincinnati, OH (US)

(21) Appl. No.: 18/895,835

(22) Filed: Sep. 25, 2024

Related U.S. Application Data
(60) Provisional application No. 63/540,508, filed on Sep. 26, 2023.

(51) Int. Cl. A01K 93/02

(52) U.S. Cl. CPC A01K 93/02

(57) ABSTRACT

A fishing attachment for use at night includes an LED bulb that is held and protected within a waterproof structure, namely, a transparent tube and a shrink-wrapped cover which seals at its opposite ends to the tube and also to a battery housing to which the LED bulb is operatively connected. When a battery is held within the battery housing, the LED bulb lights up and is therefore visible through the tube. A waterproof cap seals the top end of the tube. In use, the attachment secures to a fishing bobber that is attached to a fishing line, so that when a fish strikes a bottom end of the fishing line and pulls the bobber downwardly, the illuminated LED bulb also moves downwardly. This enables visual detection of a fish strike at in dimly lit conditions, including nighttime.

### RELATED APPLICATIONS

The present application claims priority to U.S. Provisional Application Ser. No. 63/540,508, filed on Sep. 26, 2023, entitled “Attachment For Fishing Bobber,” which is expressly incorporated by reference herein, in its entirety.

### FIELD OF THE INVENTION

The present invention relates to fishing equipment.

### BACKGROUND OF THE INVENTION

Prior U.S. Pat. No. 5,987,802 discloses a “Fishing Lure Illuminator,” while U.S. Pat. No. 9,686,972 discloses a “Fishing Float And Method.” Each of these patents is incorporated by reference herein, in its entirety.

The present invention overcomes disadvantages associated with current fishing equipment, especially with respect to fishing at night.

### SUMMARY OF THE INVENTION

The current invention is a removable and lightable attachment for a fishing bobber. This attachment illuminates, or “lights up” when the battery is attached. As a result, when secured to the bobber, and when used by a fisher who is fishing at nighttime, when it is dark, the fisher will see the light move downward when a fish strikes the hook below. Thus, while it may be too dark for the fisher to see the bobber itself move downward when a fish strikes, it will not be too dark for the fisher to see the downward movement of the light secured to the bobber. Essentially, this invention makes the bobber structure visible at nighttime to the fisher. Downward movement of the secured light and the bobber indicates when a fish has “hit” the hook that is attached below. In one respect, this inventive attachment removably secures, as by tape, or otherwise, to a standard fishing bobber, thereby permitting versatile use with a variety of different bobbers.

### BRIEF DESCRIPTION OF THE DRAWINGS

FIG. 1 is a perspective view of a fishing attachment, essentially an elongated lamp, that is used in accordance with a preferred embodiment of the invention, with a battery in place at the bottom thereof.

FIG. 2 is an exploded view of the structure shown in FIG. 1.

FIG. 3 is a front view partially in cross section shown portions of the structure shown in FIG. 1.

FIG. 4 is a longitudinal cross sectional side view thereof.

FIG. 5 is a perspective view of the structure of FIG. 1 in use, attached to a fishing bobber that is floating in water.

### DETAILED DESCRIPTION OF THE DRAWINGS

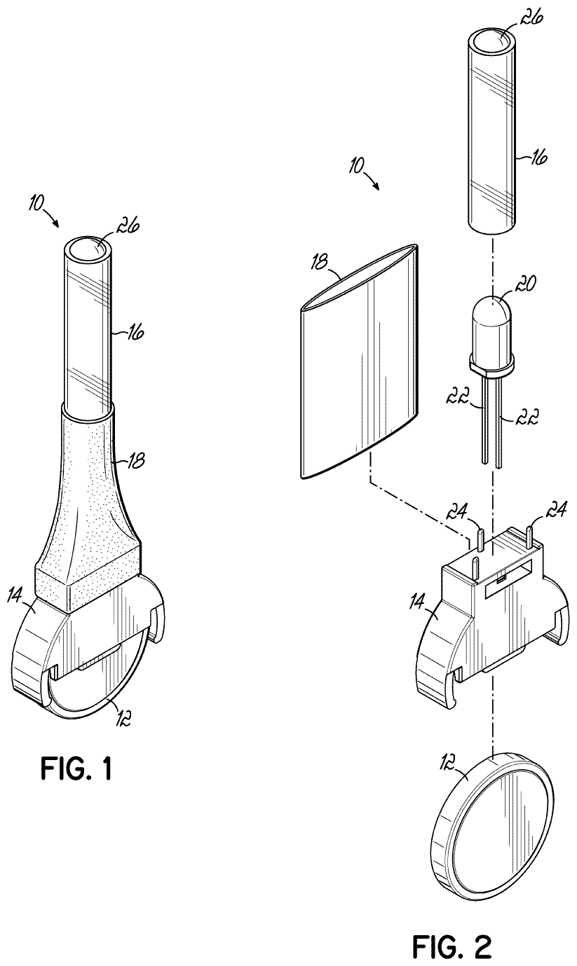

FIG. 1 shows the assembled components of a fishing attachment 10, or assembly, according to a preferred embodiment of the invention. The assembly 10 includes a battery 12 held within a socket at the bottom end of a battery housing 14, or battery socket. A tube 16, preferably transparent, or at least translucent, is located at the top of the assembly 10. A waterproof shrink cover 18 surrounds the top of the battery housing 14 and the bottom of the tube 16, to prevent water ingress. In FIG. 1, the shrink cover 18 is shown in an already-shrunken state.

FIG. 2 shows an LED bulb 20 that, when the attachment 10 assembled, resides within the tube 16. FIG. 2 shows downwardly extending electrical leads 22 of the LED bulb 20 which will operatively connect to corresponding leads 24 located on the battery housing 14, preferably by soldering. In FIG. 2 the shrink cover 18 is shown in a pre-shrunken cylindrical shape and form. FIG. 2 also shows a disc-shaped battery 12, with a shape that corresponds to battery housing 14.

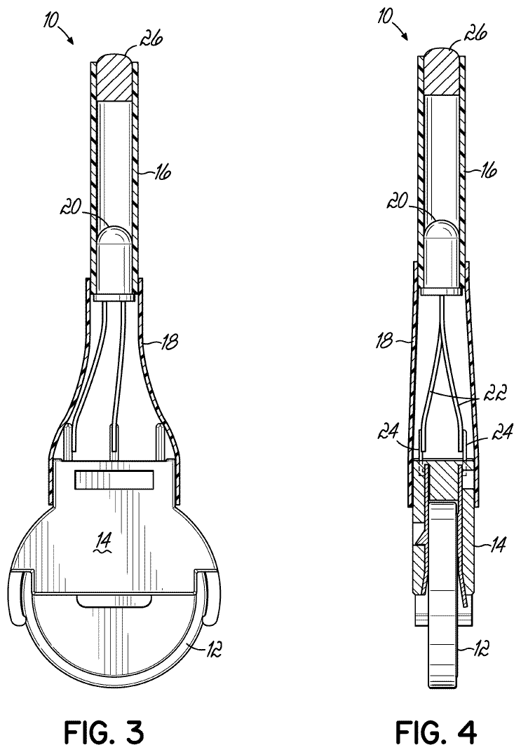

FIGS. 3 and 4 show the attachment 10 in fully assembled form, but in cross sectional views to as to enable the reader to better understand the relative positions among the various components when the attachment 10 is fully assembled. Both views include an enclosing plug 26 at the top of the tube 16, which in a preferred embodiment comprises hardened glue. This plug 26 seals off the top end of the attachment 10.

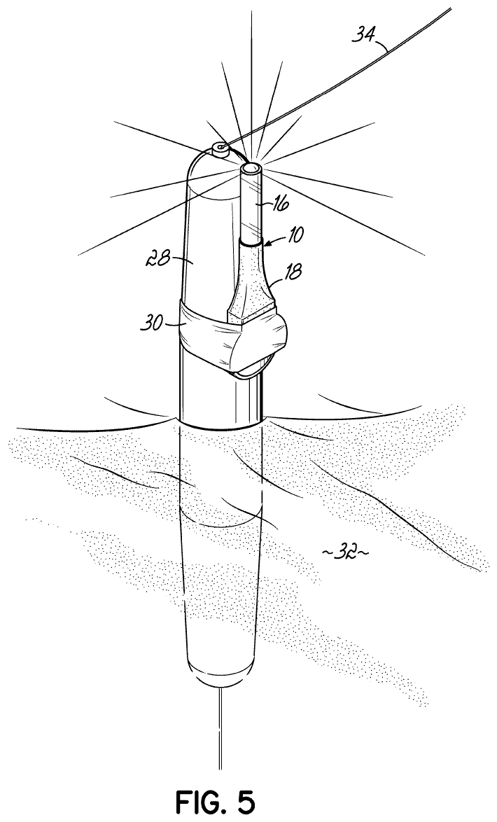

FIG. 5 show the attachment 10 in use, removably secured to a fishing bobber 28, i.e., a floater, by tape 30. Overall, the attachment 10 is relatively inexpensive, but by using tape 30 for removable securement the attachment 10 is also reusable. Tape 30 is currently preferred as the best manner of securement, but other types of securement structures could also be suitable. In FIG. 5, the bobber 28 and the attachment 10 float in the water 32, and the bobber 28 is attached to a fishing line 34. When the bobber 28 moves downwardly, as by a fish striking a baited hook (not shown) located at a bottom end of the line 34, the colored LED light 20, and also the colored light emanating from the LED bulb 20, moves downwardly with the bobber 28. This enables visual detection of a fish strike when fishing at night. If multiple lines 34 are used, each with a different colored LED bulb 20, the fisherman can determine which line 34 has been struck by the color of the bulb 20 that is moving in a downward direction.

The preferable parts list presented in the provisional application is repeated below.

### PARTS LIST

WANZELONYO C2032 Lithium Battery 3V Bulk CR 2032 Button Cell 250 Pack 230 mAh
100Pcs CR2032 Button Cell Battery Sockets Holder Case Plastic Shell Type, Black Color
CHANZON 100 pcs 5 mm Pink LED Diode Lights (Clear Round Transparent DC 3V 20 mA) Bright Lighting Bulb Lamps Electronics Components Indicator Light Emitting Diodes (RED, GREEN, BLUE, WHITE, ORANGE, PINK, MULTI COLOR)
¼ in. O.D.×0.170 in. I.D.×25 ft. Natural Polyethylene Tubing
Hot Glue
Tyton Heat Shrink Tuing ½ in
½ Inch Round Color Circle Dot Sticker Labels 10 Assorted Colors Circle Dot Labels Coding Sticker Adhesive Colored Sticker Solid Color Round Sticker
2″×3″ Clear Plastic Resealable Zip Bags, Bulk 2 Mil, Strong And Durable Poly Baggies With Resealable Zip Top Lock

These parts are shown below in the photographic Figures that were included in the provisional application.

Although this specification discloses one currently preferred embodiment of the present invention, those skilled in the art will appreciate that the disclosed invention is amenable to reasonable variation and modification, particularly with respect to dimensions. Accordingly, the following claims, and not this specification, should be used to define this invention.

We claim:

1. The invention, in combination, comprising:
a fishing bobber; and
an attachment removably secured to the fishing bobber, the attachment including a battery-powered light, wherein the removably secured attachment is removably secured to the bobber by tape.

2. The invention of claim 1 wherein the attachment further includes:
an LED bulb;
a battery socket with a battery held therein, the LED bulb operatively connected to the battery socket via electrical connectors;
a waterproof sleeve extending between the LED bulb and the battery socket to provide a waterproof enclosure therefore; and
a waterproof tube extending upwardly from the waterproof sleeve and holding the LED bulb therein, with a cap located at a top end of the tube to prevent water ingress.

3. The invention of claim 2 wherein the waterproof tube is transparent.

4. A method of making a fishing attachment comprising:
operatively connecting an LED bulb to a battery socket;
inserting the LED bulb into one end of a transparent tube;
closing off an opposite end of the tube with a hot glue that cures to close off said opposite end;
shrink wrapping a cylindrical cover over the battery socket and the tube, to prevent water ingress; and
inserting a battery into the battery socket to thereby power the LED bulb, whereby when in a powered state the attachment is visible at night.

5. The method of claim 4 and further comprising:
securing the attachment to a fishing bobber so that the LED light will move with the bobber.

6. The method of claim 5 wherein securement occurs in a removable manner by tape.

7. A fishing attachment made according to the method of claim 1.
